(19) United States
(12) Patent Application Publication
(10) Pub. No.: US 2025/0276729 A1
(43) Pub. Date: Sep. 4, 2025

(54) Stroller with Luggage Bay Protection

(71) Applicant: CARROT CARRIAGE LLC, Jersey City, NJ (US)

(72) Inventors: Jordan Britt Lovato, Moorestown, NJ (US); Heather Parisi, Port Jefferson, NY (US)

(21) Appl. No.: 18/592,212

(22) Filed: Feb. 29, 2024

(51) Int. Cl. B62B 9/26; B62B 7/04; B62B 9/08; B62B 9/10

(52) U.S. Cl. CPC B62B 9/26; B62B 7/044; B62B 9/08; B62B 9/104; B62B 2301/04; B62B 2301/252

(57) ABSTRACT

A new child-carrying stroller is provided that includes an accommodating support structure, specialized to create a new form of luggage bay while supporting and protecting a child-seating section above the luggage bay. In some embodiments, such a support structure includes three curved, interconnected struts forming an outer protective cage, and defining a luggage bay suitable for accepting and holding a piece of carry-on luggage. In some embodiments, such a protective cage protects elements inside and outside of the luggage bay, including the child-seating section, and a child within it. In some embodiments, the three interconnected vertical struts are each connected to a wheel, at their base, and at least some of the wheels are configured to lock or rotate freely in any rotational direction. In some embodiments, a control system including computer hardware and software is provided to control wheel locking and manage rental time periods for the stroller.

### TECHNICAL FIELD

This specification relates to small-wheeled vehicles and, in particular, to child-carrying strollers and systems and methods related thereto.

### BACKGROUND

Child-carrying strollers date back at least to Victorian England in 1733, and remain a primary device for transporting babies and other small children from one location to another. New parents usually purchase one or more strollers for their private use, for this purpose. A typical child-carrying stroller will have a seat and a means to secure an infant or child to the seat, a means such as a handle for pushing and controlling the direction of the stroller, and wheels (most often, four).

However, at many locations, many parents are unable to bring or effectively use their strollers, for a wide variety of reasons. In some environments featuring tight spaces and uneven terrain, the bulk, weight and awkward unwieldiness of strollers make effective use impractical. In travel, including at airports, parents are permitted to bring their own strollers. This aids parents for a wide variety of reasons, by allowing them to use a trusted child-transportation device they are familiar with, and avoid hand-carrying their children, both at the departing city and airport, and in destination cities and airports. However, the use of strollers at airports, and in other public settings, can be impractical, for a wide variety of reasons. For example, the bulk, weight and awkward unwieldiness of strollers make transportation through security lines challenging. And parents, at times, prefer to carry their children on their person, in this setting.

There remains a long-felt need for improved child-carrying strollers, particularly in the context of commercial transportation.

It should be understood that the disclosures in this application related to the background of the invention, in, but not limited to this section titled “Background,” do not necessarily set forth prior art or other known aspects exclusively, and may instead include art that was invented concurrently or after the present invention and conception, and details of the inventor's own discoveries and work and work results.

### SUMMARY

The present invention relates to new child-carrying strollers and systems and methods related thereto. In some embodiments, a child-carrying stroller is provided that includes a new form of accommodating support structure, specialized to create a new form of luggage bay while supporting a child-seating section above the luggage bay. In some embodiments, such a support structure includes an outer protective cage, defining a luggage bay suitable for accepting and holding at least one piece of luggage. For example, in some embodiments, such a luggage bay includes a storage volume surrounded by such an outer protective cage suitable for accepting and holding a piece of carry-on luggage, meaning a piece of luggage within a range of accepted shapes, weights, sizes and other physical constraints maintained for a piece of luggage to be carried onto a commercial aircraft. In some embodiments, such a protective cage protects elements inside and/or outside of the luggage bay. For example, in some embodiments, such an outer protective cage is provided that protects a child seated in such a child-seating section from luggage being loaded into and out of the luggage bay. Conversely, in some embodiments, alternatively or in addition to such embodiments, an outer protective cage is provided that protects luggage being loaded into and/or out of the luggage bay from damage from external elements (e.g., collisions with obstacles). In some embodiments, as discussed in further detail below, an outer protective cage is formed, at least in part, by a plurality of interconnected tubes, bars, and/or struts, examples of which are discussed in greater detail below. For example, in some embodiments, such tubes, bars, and/or struts include one or more of a plurality of legs of such a child-carrying stroller, as discussed further below. However, in some embodiments, such tubes, bars, and/or struts may include one or more other element(s), as also discussed below. In any event, in some embodiments, in addition to providing such protection, such tubes, bars and/or struts form a main structural frame for the stroller.

In some embodiments such a luggage bay of the child-carrying stroller includes at least one bottom-defining strut, providing a luggage-holding platform at the bottom of the luggage bay. And, in some such embodiments, such a luggage bay of the child-carrying stroller includes a plurality of such bottom-defining struts. In some embodiments, such a luggage-holding platform may be in the form of an at least generally flattened floor, which may cover the entire lower side of such a luggage bay, in some such embodiments. In any event, in some embodiments, the luggage-holding platform is, in turn, supported by additional, lower side walls of the stroller. In some embodiments, the lower sidewalls and/or generally flattened floor of the luggage bay may be or include a flat surface configured in a horizontal orientation. In some embodiments, the lower sidewalls and/or lower floor may be or include a flat surface configured in an approximately horizontal orientation. However, in some embodiments, the lower sidewalls and/or lower floor may be or include a flat surface including an incline or slope, relative to a floor on which the stroller is riding. And, in some such embodiments, such an incline or slope may be pitched to descend toward a front of the stroller. And, in some such embodiments, at least one of the opening(s) to the luggage bay may be provided on the opposite, rear side of the stroller.

In some such embodiments, the lower side walls are each connected to a front leg or strut of such a child-carrying stroller, which is connected directly with a front wheel or roller (or a housing thereof) of the child-carrying stroller. And, in some embodiments, the lower sidewalls are also each connected with one rear leg or strut, themselves being connected with one rear wheel or roller each. In some embodiments, such lower side walls are arranged in a carrot-, V- or wedge-shape, or substantially in a carrot-, V-, or wedge-shape. Thus, in some embodiments, the stroller and/or the luggage bay is generally carrot-, V-, or wedge-shaped, due to the carrot-, V-, or wedge-shape of the lower sidewalls and other components attached thereto.

In some embodiments, such a luggage bay includes a plurality of support legs, which may be each connected to at least one wheel, in some such embodiments. For example, in some embodiments, which are preferred, such a plurality of legs is three legs. However, in various embodiments, fewer or more numerous legs (e.g., 1, 2, 4, 5 or 6 legs, in various embodiments) may be included, while still falling within the scope of this specification, as will be apparent to those of skill in the art. In some such embodiments, such a plurality of support legs surround and define lateral sides of such a luggage bay. In some such embodiments, such a plurality of support legs also define a ceiling of such a luggage bay.

And, in some embodiments, such a plurality of support legs are spaced apart from each other to create at least one entrance complementary to, and capable of accepting, at least one piece of luggage. In some such embodiments, such a plurality of support legs are spaced apart from each other to create a plurality of entrances complementary to, and capable of accepting, certain forms of carry-on luggage at an airport. For example, in some such embodiments, three such entrances are provided, e.g., between three such support legs.

And because, as discussed above, in some embodiments each of such legs is attached to at least one wheel of the stroller, in embodiments having three such legs, for example, three such wheels may be provided, in some such embodiments, creating a triangular configuration of such wheels. In some embodiments, such a triangular (or “carrot-like”) configuration may be similarly created by other elements of the child-carrying stroller.

In some embodiments, one or more of the (e.g., 3) wheels may include a ball or other spherical roller. For example, in some embodiments, a front wheel, directed away from the child-seating section (and an adult user of the child-carrying stroller) may be in the form of a ball or other spherical roller. In some such embodiments, such a ball or other spherical roller is mounted for free movement in any rotational direction. For example, in some such embodiments, such a ball or other spherical roller is mounted in a socket located in a front wheel housing (e.g., allowing for 360-degree swivel, and free rotation in any other rotational direction). In some such embodiments, the remaining (e.g., 2) rear wheels may be in the form of, or approximately in the form of, a round, flat wheel. And, in some embodiments, one or more of those remaining, rear wheels, may be arrested with the aid of a brake, as will be discussed in greater detail below. In some embodiments, the rear wheels are mounted (e.g., on an axel) for 360-degree vertical plane rotation. However, in some embodiments, the rear wheels are also mounted on a swivel (e.g., allowing 360-degree horizontal rotation of the rear wheel, and, in some embodiments, wheel assemblies including the rear wheels. Thus, in some embodiments, the rear wheels are capable of pivoting and rotating in a wide range of directions.

In some embodiments, such a luggage bay is located directly below the child-seating section. In some such embodiments, the ceiling of the luggage bay serves as a support for the child-seating section. However, alternatively, in some embodiments, such a child-seating section is located above, but not directly above, such a luggage bay. For example, in some embodiments, such a child-seating section is provided at least partially above an area adjacent to such a luggage bay. And, in some embodiments, which are preferred, the child-seating section is provided above an auxiliary, personal item storage area (e.g., in the form of a box) which, in turn, is located above the luggage bay. In some embodiments, such a personal item storage area includes shielding materials providing protection for a child held in the child-seating section, which protection may be additional and synergistic to the protection provided by an outer protective cage, embodiments of which are discussed further throughout this specification. In some embodiments, such a protective cage may include, form, and/or approximate, a supportive structure. For example, in some embodiments, such a supportive structure may be, or generally be, spherical and/or hemispherical, in shape. As another example, in some embodiments, such a supportive structure may be, or generally be, in the form of an arch and/or dome. As yet another example, in some embodiments, such a supportive structure may be, or generally be, in the form of a triangle, A-frame and/or pyramid. In some embodiments, the protective cage includes, or is substituted by, one or more protective guard(s). In some embodiments, the protective cage includes, or is substituted by, at least one outer housing.

As mentioned above, in some embodiments, such a stroller also includes an auxiliary, personal item storage area, which may be smaller, in at least some dimension(s) than the luggage bay of the stroller. In some such embodiments, such a personal item storage area is located on the rear side of a seatback of the child-seating section, instead of a location below the child-seating section. In some embodiments, the personal item storage area includes a bag, pocket or compartment that covers the entire seatback, or substantially the entire seatback. In some embodiments, the seatback and/or the bag, pocket or compartment measures, or approximately measures, 16.5 inches in height and 20 inches in width. However, in some embodiments, such a personal item storage area is located elsewhere (e.g., between the child-seating section and the luggage bay). In some embodiments, the seatback of the stroller is reclinable, and, in some such embodiments, may be fully reclinable, to a horizontal orientation (or nearly so). In some embodiments, the seatback may partially recline, e.g., to a reclining slope of 98.5 degrees to 125 degrees orientation, allowing an infant in the baby-holding seating section to relax and/or sleep more easily. In some embodiments, the seatback may more fully recline, e.g., to a flat or approximately flat orientation, allowing a child in the child-seating section to relax and/or sleep more easily.

In some embodiments, the rear of such a child-carrying stroller and luggage bay include an open back, allowing the stroller to nest with other, ed strollers, meaning that the pointed front tip of one such stroller may enter the open back of another such stroller, for efficient storage. In at least some such embodiments, a bottom-defining strut(s) of the luggage bay is provided, which do/does not cover the entire lower side of such a luggage bay, aiding in such nesting.

In some embodiments, a second tube or bar frame is provided, which is connected to one or more handlebar(s) of such a stroller, and the remainder of the stroller. In some such embodiments, such handlebar(s) are located behind the baby seating section, enabling a user to push, pull and steer such a stroller.

In some embodiments, the stroller includes a control system, comprising specialized computer hardware and software, configured for controlling one or more input and output devices and communicatively connected with a remote computer system, under the control of an administrative user. For example, in some embodiments, such a control system aids in the administration of rentals and rental reservation periods, in which such a stroller is rented to a user of such a stroller (e.g., an air traveler). In some such embodiments, such rental reservation periods are enforced by the control system safely disabling or enabling such a stroller for movement, at or about the end of a rental period. For example, in some such embodiments, such a stroller is so disabled or enabled by such a control system actuating a servo-motor, brake, wheel-lock, or other actuator, powered by and/or communicatively connected with the control system, either to stop or free the wheels for rotation, respectively. In some embodiments, such a wheel-lock is located on or about one or more of the wheels of the stroller.

In some embodiments, an artificial intelligence sub-module or other aspect of the control system is included, which controls the disabling of such a stroller at the end of such a rental period, based on data and information gained with the aid of sensors within the control system. For example, in some embodiments, the control system may either 1) immediately administer a wheel lock; or 2) delay or more slowly administer a wheel lock or other braking subsystem of the control system and stroller, depending on stroller speed, orientation, location, and other status information.

In some embodiments, the control system records and reports a geolocation (e.g., via a G.P.S. subsystem of the control system) of such a stroller to an administrative user of the control system. In some embodiments, the control system may end such a rental period based on such a geolocation exceeding a geofenced area assigned to the rental of such a stroller.

### Canons of Construction

Where any term is set forth in a sentence, clause or statement (“statement”) in this application, each possible meaning, significance and/or sense of any term used in this application should be read as if separately, conjunctively and/or alternatively set forth in additional statement(s), after the sentence, clause or statement, as necessary to exhaust the possible meanings of each such term and each such statement.

It should also be understood that, for convenience and readability, this application may set forth particular pronouns and other linguistic qualifiers of various specific gender and number, but, where this occurs, all other logically possible gender and number alternatives should also be read in as both conjunctive and alternative statements, as if equally, separately set forth therein.

The embodiments set forth in detail in this application are to ease the reader's understanding of inventions set forth herein and, as such, are only examples of the virtually innumerable number of alternative embodiments falling within the scope of the application. No specific embodiment set forth in this application should be read as limiting the scope of any claimed inventions; the inventions of the present application are not limited to any particular preferred embodiment disclosed. These and other embodiments falling within the scope of the present inventions will become readily apparent to those skilled in the art from the following detailed description of the preferred embodiments having reference to the attached figures.

This Summary, the Abstract, and other parts of the application, are for ease of understanding only, and no part of this application should be read to limit the scope of the invention, whether or not it references matter in any other part.

### BRIEF DESCRIPTION OF THE DRAWINGS

The features and advantages of example embodiments will become more apparent from the detailed description set forth below when taken in conjunction with the following drawings:

FIG. 1 is a perspective view of an example child-carrying stroller including a luggage bay, in accordance with some embodiments set forth in this application.

FIG. 2 is a left side view of the example child-carrying stroller with a luggage bay set forth above, in FIG. 1, in accordance with some embodiments.

FIG. 3 is a n a view of the example child-carrying stroller with a luggage bay set forth above, in FIG. 1, in accordance with some embodiments.

FIG. 4 is a perspective view of another example child-carrying stroller, in accordance with additional embodiments.

FIG. 5 is a schematic block diagram of some elements of a control system in accordance with some example embodiments of the invention.

FIG. 6 is a process flow diagram, illustrating several example steps that may be carried out by a control system, such as the example control system set forth in reference to FIG. 5, comprised in, or comprising, a stroller rental management system, in accordance with some additional embodiments.

FIG. 7 is a perspective view of two additional example alternative embodiments of a child-carrying stroller, each with a luggage bay including a hinged, raisable generally flattened floor, in accordance with some additional embodiments.

FIG. 8 is a bottom view of an example embodiment of a child-carrying stroller, which may be the same as or similar in nature to, each of the child-carrying strollers set forth above, in reference to FIG. 7, having a luggage bay including a hinged, raisable generally flattened floor, in accordance with some additional embodiments.

FIG. 9 is a top view of an example embodiment of a child-carrying stroller, which may be the same as or similar in nature to, each of the child-carrying strollers set forth above, in reference to FIGS. 7 and 8, in accordance with some additional embodiments.

FIG. 10 is a right, side view of an example embodiment of a child-carrying stroller, which may be the same as or similar in nature to, each of the child-carrying strollers set forth above, in reference to FIGS. 7-9, in accordance with some additional embodiments.

FIG. 11 is a left, side view of an example embodiment of a child-carrying stroller, which may be the same as or similar in nature to, each of the child-carrying strollers set forth above, in reference to FIGS. 7-10, in accordance with some additional embodiments.

FIG. 12 is a front view of an example embodiment of a child-carrying stroller, which may be the same as or similar in nature to, each of the child-carrying strollers set forth above, in reference to FIGS. 7-11, in accordance with some additional embodiments.

FIG. 13 is a back view of an example embodiment of a child-carrying stroller, which may be the same as or similar in nature to, each of the child-carrying strollers set forth above, in reference to FIGS. 7-12, in accordance with some additional embodiments.

### DETAILED DESCRIPTION

The features and advantages of example embodiments of the invention presented herein are directed to new child-carrying strollers, and devices and methods for managing the rental of such child-carrying strollers, which are now described herein. This description is not intended to limit the application of the example embodiments presented herein. In fact, after reading the following description, it will be apparent to one skilled in the relevant art(s) how to implement the following example embodiments in alternative embodiments.

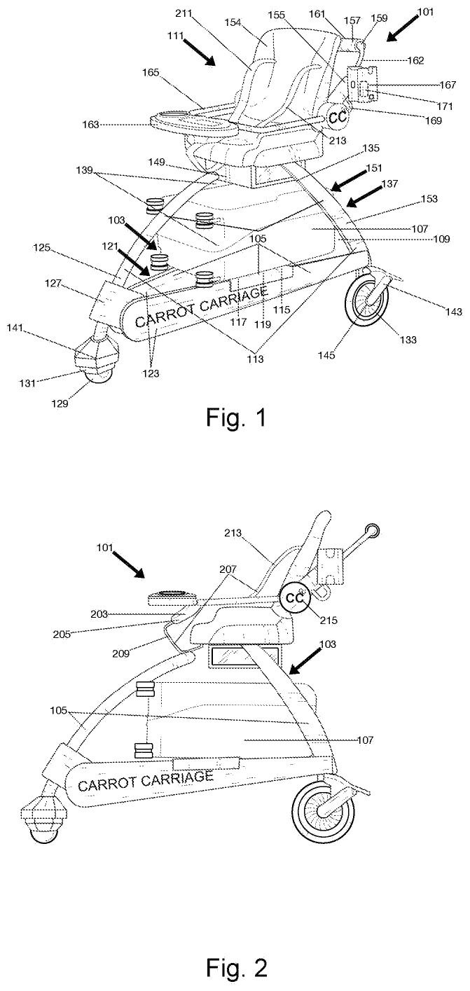

Embodiments of an example child-carrying stroller 101 in accordance with some aspects set forth in this Specification are depicted in FIGS. 1 through 6. The following is a list of defined components and reference numbers therefor, as used throughout the figures:

| Reference No. | Component |
|---|---|
| 101 | child-carrying stroller |
| 103 | luggage bay |
| 105 | outer protective cage |
| 107 | hard-cased carry-on suitcase |
| 109 | storage volume |
| 111 | child-seating section |
| 113 | plurality of legs |
| 115 | luggage-holding platform |
| 117 | bottom-defining strut |
| 119 | at least generally flattened floor |
| 121 | lower side (of luggage bay) |
| 123 | lower side walls |
| 125 | front leg |
| 127 | front bracket |
| 129 | front wheel or roller |
| 131 | roller socket mount |
| 133 | rear wheel |
| 135 | ceiling (of luggage bay) |
| 137 | main entrance (of luggage bay) |
| 139 | plurality of entrances |
| 141 | front wheel housing |
| 143 | brake |
| 145 | axel |
| 149 | personal item storage area |
| 151 | arch and/or dome |
| 153 | guard |
| 154 | seatback |
| 155 | handlebar peripheral frame |
| 157 | handlebar(s) |
| 159 | spine |
| 161 | rounded handle |
| 162 | extendable struts |
| 163 | swivel-mounted feeding tray |
| 165 | peripheral frame (for feeding tray) |
| 167 | personal digital device holder |
| 169 | garment-hanging hook(s) |
| 171 | local computer |
| 203 | yoke |
| 205 | 3-point seatbelt fastener |
| 207 | child-restraining harness |
| 209 | central, lower seatbelt |
| 211 | right-hand side seatbelt |
| 213 | left-hand side seatbelt |
| 215 | indicia |
| 301 | right-hand side rear wheel |
| 353 | right-hand side brake |
| 381 | indicia |
| 401 | child-carrying stroller (additional embodiment(s)) |
| 402 | rounded strut |
| 403 | luggage bay |
| 405 | yoke |
| 411 | child-seating section |
| 413 | seatback |
| 463 | swivel-mounted feeding tray |
| 465 | peripheral frame (for feeding tray) |
| 467 | raised position (of feeding tray and peripheral frame) |
| 469 | underside (of feeding tray) |
| 471 | central, lower seatbelt |
| 472 | right-hand side seatbelt |
| 473 | left-hand side seatbelt |
| 475 | rear wheels |
| 500 | control system |
| 501 | input/output device |
| 503 | memory device |
| 505 | long-term data storage device |
| 507 | processor(s) |
| 509 | Internet server(s) |
| 511 | local machine(s) |
| 513 | cameras and microphones |
| 514 | sensor(s) |
| 515 | ubiquitous computing devices |
| 517 | application programming interface |
| 518 | scanner |
| 519 | stroller-mounted [symbol] tablet computer and display |
| 520 | [symbol] personal digital device (PDA) |
| 600-621 | method steps |
| 701 | child-carrying stroller (another additional embodiment) |
| 703 | child-carrying stroller (embodiment with hinged, raisable |
| | generally flattened floor lifted) |
| 705 | luggage bay (additional embodiment) |
| 707 | luggage bay (additional configuration) |
| 709 | hinged, raisable generally flattened floor |
| 711 | hinged, raisable generally flattened floor (additional |
| | configuration) |
| 713 | rear valence |
| 715 | push motion arrow |
| 717 | |

FIG. 1 is a perspective view of an example child-carrying stroller 101 including an example luggage bay 103, in accordance with some embodiments set forth in this application. In some such embodiments, such a luggage bay 103, includes an outer protective cage 105, defining luggage bay 103, and suitable for accepting and holding at least one piece of luggage (such as example hard-cased carry-on suitcase 107). Thus, outer protective cage 105 accommodates an adult user's carry-on luggage within a storage volume 109 surrounded by outer protective cage 105, while also serving as a main support structure for child-carrying stroller 101.

In some embodiments, protective cage 105 protects elements inside and/or outside of the luggage bay. For example, in some embodiments, protective cages protects a child (not pictured) seated in such a child-seating section 111 of child-carrying stroller 101 from luggage being loaded into and out of luggage bay 103. Conversely, in some embodiments, protective cage 105 protects luggage loaded into and/or out of the luggage bay, such as carry-on suitcase 107, from damage from external elements (e.g., collisions with obstacles).

In some embodiments, protective cage 105 is formed, at least in part, by a plurality of interconnected tubes, bars, and/or struts. For example, in some embodiments, such tubes, bars, and/or struts include one or more of a plurality of legs 113 of child-carrying stroller 101. However, in some embodiments, such tubes, bars, and/or struts may include one or more other element(s), as also discussed below. In any event, in addition to providing protection, such legs 113, and/or other interconnected tubes, bars and/or struts of the protective cage, form a main structural frame for the stroller, in some embodiments. For example, in some embodiments, legs 113, and/or other interconnected tubes, bars and/or struts of the protective cage, support child-seating section 111, located above luggage bay 103.

As an example of such other interconnected tubes, bars and/or struts of protective cage 105, in some embodiments, a luggage-holding platform 115 is provided, at or about the bottom of luggage bay 103. In some embodiments, as pictured, luggage-holding platform 115 includes a bottom-defining strut 117. And, in some alternative embodiments (not pictured), luggage bay 103 and luggage-holding platform 115, within it, includes a plurality of bottom-defining struts. In some embodiments, luggage-holding platform 115 may include or provide an at least generally flattened floor 119, covering the entire lower side 121 of luggage bay 103, in some such embodiments. In any event, in some embodiments, luggage-holding platform 115 is, in turn, supported by additional, lower side walls 123 of child-carrying stroller 101.

In some embodiments, lower side walls 123 are generally flat in shape, and each are directly connected to a front leg 125 of child-carrying stroller 101. For example, as pictured, in some embodiments, lower side walls 123 are connected to front leg 125 via a front bracket 127, which may also serve as a streamlined fairing for the child-carrying stroller, in some embodiments. In some such embodiments, front leg 125, is, in turn, connected directly with a front wheel or roller 129 (e.g., via roller socket mount 131). And, in some embodiments, lower sidewalls 123 are also connected with one rear leg or strut each, which, in turn are attached to one rear wheel or roller, such as example rear wheel 133, each. As can be seen in the figure, in some embodiments, lower side walls 123 are arranged in a carrot-, V- or wedge-shape, or substantially in a carrot-, V-, or wedge-shape. Thus, in some embodiments, child-carrying stroller 101 and luggage bay 103 is also generally carrot-, V-, or wedge-shaped, due to the carrot-, V-, or wedge-shape of the lower sidewalls and other components attached thereto.

In some embodiments, which are preferred, child-carrying stroller 101 has three (3) legs (two of which being pictured in the present figure as part of plurality of legs 113). However, in various embodiments, fewer or more numerous legs (e.g., 1, 2, 4, 5 or 6 legs) may be included, while still falling within the scope of this specification, as will be apparent to those of skill in the art. Where, as pictured, 3 legs are included in child-carrying stroller 101, the arrangement creates a triangular configuration of wheels, again, as pictured. In some embodiments, such a triangular (or “carrot-like) configuration may be similarly created by other elements of the child-carrying stroller, as discussed elsewhere in this application.

As discussed above, in some such embodiments, plurality of legs 113 surround and define lateral sides of luggage bay 103. In some such embodiments, legs 113 also aid in defining a ceiling 135 of luggage bay 103. In some embodiments, legs 113 are spaced apart from each other to create at least one entrance complementary to, and capable of accepting, at least one piece of luggage, such as example main entrance 137 to luggage bay 103. And, in some such embodiments, legs 113 are spaced apart from each other to create a plurality of entrances 139, each of which are complementary to, and capable of accepting, certain forms of carry-on luggage at an airport. For example, in some such embodiments, plurality of entrances 139 includes three such entrances are provided, as pictured.

In some embodiments, one or more of the wheels of child-carrying stroller 101 may include a ball or other spherical roller, such as example pictured as front wheel or roller 129. In some such embodiments, such a ball or other spherical roller is mounted for free movement in any rotational direction. For example, in some such embodiments, such a ball or other spherical roller is mounted in roller socket mount 131, or another form of socket located in a front wheel housing 141. In some such embodiments, such a wheel or roller socket mount 131 allows for 360-degree swivel, and free rotation in any other rotational direction. In some such embodiments, the remaining two rear wheels, such as example rear wheel 133, may be in the form of, or approximately in the form of, a round, flat wheel, as pictured. And, in some embodiments, one or more of those remaining, rear wheels, may be arrested with the aid of a brake 143, as will be discussed in greater detail below. In some embodiments, the rear wheels are mounted (e.g., on an axel 145) for 360-degree vertical plane rotation. However, in some embodiments, the rear wheels are also connected to a swivel (not pictured) e.g., allowing 360-degree horizontal rotation of the rear wheel, and, in some embodiments, wheel assemblies including the rear wheels. Thus, in some embodiments, the rear wheels are capable of pivoting and rotating in a wide range of directions.

As pictured, luggage bay 103 is located directly below child-seating section 111, in some embodiments, and the ceiling 135 of luggage bay 103 serves as support for child-seating section 111. However, alternatively, in some embodiments, such a child-seating section is located above, but not directly above, luggage bay 103. For example, in some embodiments, such a child-seating section is provided at least partially above an area adjacent to luggage bay 103. And, in some embodiments, which are preferred, child-seating section 111 is provided above an auxiliary, personal item storage area 149 (e.g., in the form of a box with an open side, as pictured) which, in turn, is located above the luggage bay. In some embodiments, personal item storage area 149 includes shielding materials providing protection for a child held in the child-seating section. And, in some embodiments, the personal item storage area is enclosed, or at least partially enclosed, within a privacy-protecting opaque wall(s).

In some embodiments, protective cage 105 may include, form, and/or approximate, a supportively-shaped structure. For example, in some embodiments, such a supportively-shaped structure may be, or generally be, spherical and/or hemispherical, in shape. As another example, in some embodiments, as pictured, such a supportive structure may be, or generally be, in the form of an arch and/or dome 151. As yet another example, in some embodiments, such a supportive structure may be, or generally be, in the form of a triangle, A-frame and/or pyramid. In some embodiments, the protective cage includes, or is substituted by, one or more protective guard(s), such as example guard 153. In some embodiments, the protective cage includes, or is substituted by, at least one outer housing (not pictured).

As discussed above, auxiliary, personal item storage area 149 may be smaller, in one or more dimension(s) than luggage bay 103, and may be suitable for holding a personal item of an air traveler, meaning an item within a range of accepted shapes, weights, sizes and other physical constraints maintained for items other than carry-on luggage, to be carried onto a commercial aircraft. In some alternative embodiments, such a personal item storage area is located on the rear side of a seatback 154 of the child-seating section, instead of a location below the child-seating section pictured. In some embodiments, such a personal item storage area includes a stretchable bag or compartment and/or an upward-facing, stretchable opening and force biasing tending to hold the opening closed.

In some embodiments, the seatback of the stroller is reclinable, and, in some such embodiments, may be fully reclinable, to a horizontal orientation (or nearly so), at the election of an adult user (e.g., via a seatback ratcheting or other reclining seatback control).

In some embodiments, a handlebar peripheral frame 155 is provided, mounted to the remainder of the child-carrying stroller 101, which is connected to one or more handlebar(s) 157 of the child-carrying stroller. In some such embodiments, such handlebar(s) are located behind baby seating section 111, enabling an adult user to push, pull and steer such a stroller. In some embodiments, handlebar(s) 157 include a spine 159 at the center of a rounded handle 161. In some embodiments, handlebars 157 and auxiliary frame 155 is/are, a least generally, T-shaped. In some embodiments the auxiliary frame 155 and/or handlebars 157 has/have an adjustable height. In some embodiments the auxiliary frame 155 and/or handlebars 157 are extendable (e.g., via extendable struts 162.)

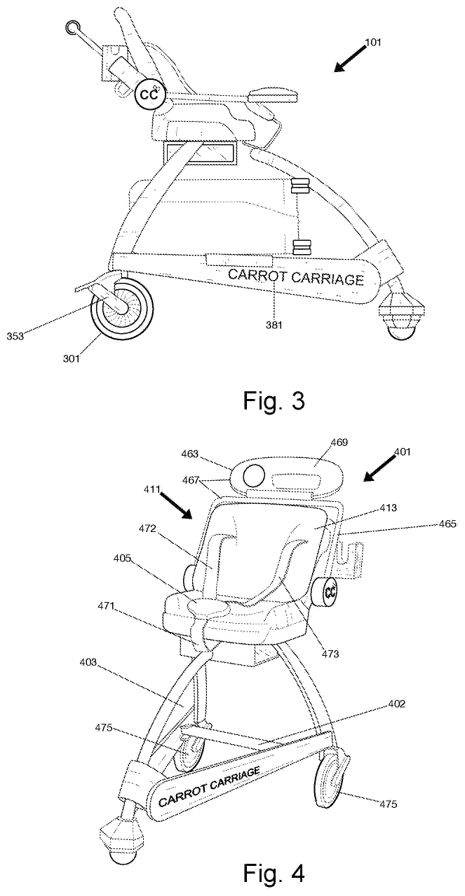

In some embodiments, a swivel-mounted feeding tray 163 is provided, mounted on an additional peripheral frame 165, which is capable of toggling between two positions: 1) a feeding position, in which the feeding tray is in a generally horizontal orientation (as pictured), and 2) a raised position, in which the feeding tray is in a generally vertical orientation, and an underside of the feeding tray is exposed and positioned out of the way of an entrance to the baby seat, as is shown and will be discussed below, in reference to FIG. 3.

In various additional embodiments, a number of additional elements may be included, mounted on or otherwise connected with, child-carrying stroller 101. For example, in some embodiments, a personal digital device holder 167 is included, allowing a user to stow and mount her or his personal digital device (“PDA”), such as a smartphone, to child-carrying stroller 101. In some embodiments, such a user may connect such a PDA to a control system, such as any of the example control systems set forth in the present application. For example, in some embodiments, by placing a PDA into the personal digital device holder 167, the PDA interfaces with a control system, such as any of the control systems set forth below, to aid in the management of the child-carrying stroller 101. In other words, in some embodiments, an interface is included within personal digital device holder 167, configured to create connections with such a control system (6-9-8.9., for providing power and communications between the PDA, stroller and/or such a control system. In some embodiments, as discussed above, a local computer may be included within child-carrying stroller 101 with its own touchscreen or other graphical user interface (“GUI”) for communications with such a control system. In any event, in some embodiments, such a local computer and/or touch screen includes software to accept credit cards and/or codes to initiate a rental or display user instructions. In some embodiments such a touch screen includes a digital map of the airport, for example, displaying present location(s) of the child-carrying stroller 101.

As another example of such possible additional elements, in some embodiments, one or more garment-hanging hook(s) 169 may be included, mounted on or otherwise connected with, child-carrying stroller 101, such that a user can store a garment, shopping bag or other hangable item.

In some embodiments, child-carrying stroller 101 includes an open back, configured for nesting with at least one other stroller, of a similar size shape and configuration to child-carrying stroller 101. In some embodiments, the rear of child-carrying stroller 101 and luggage bay 103 include an open back at the lower end of child-carrying stroller 101, allowing it to nest with other, similarly-shaped strollers, meaning that the pointed front tip of one such stroller may enter the open lower back of another such stroller, for efficient storage. In at least some such embodiments, a bottom-defining strut(s) of the luggage bay, such as example bottom-defining strut 117, is provided which does not cover the entire lower side of such a luggage bay, aiding in such nesting.

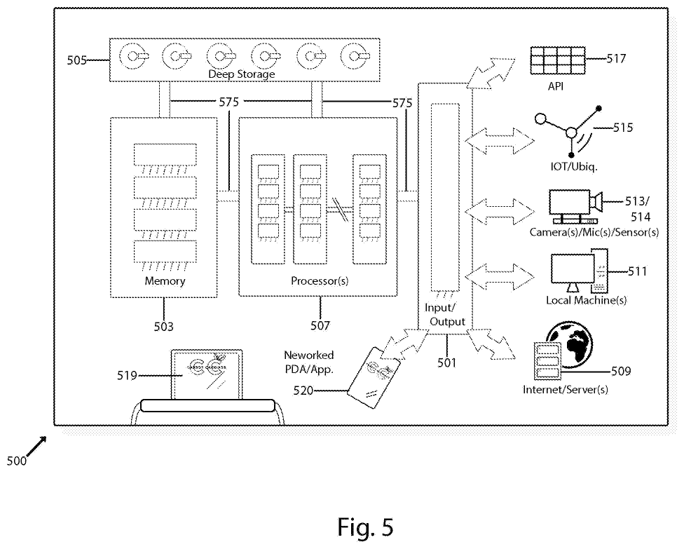

As mentioned above, in some embodiments, the child-carrying stroller 101 includes a local computer 171, comprising and/or comprised in a control system (which may be a control system such as and of the example control systems discussed in reference to FIG. 5, below). In such embodiments, such a control system comprises specialized computer hardware and software, configured for controlling one or more input and output devices, and may be communicatively connected with a remote computer system, under the control of an administrative user. In various embodiments, such a control system aids in the management of any of the methods and techniques set forth in this application, examples of which will be discussed in greater detail below. For example, in some embodiments, such a control system aids in the administration of rentals and rental reservation periods, by safely disabling or enabling such child-carrying stroller 101 for movement, at or about the end of a rental period. For example, in some such embodiments, such a stroller is so disabled or enabled by such a control system actuating a brake 143, located on one of the child-carrying stroller 101's wheels, which powered by and/or communicatively connected with the local computer 171, either to stop or free the wheels for rotation, respectively.

As will be apparent to those of ordinary skill in the art to which the present invention applies, a wide range of alternative structures, numbers, arrangements and techniques for luggage management and baby strollers may include, or be modified to include or combine with, the aspects and techniques of the present invention, as set forth in this application, in various embodiments. The mention, depiction or discussion of any specific language, type or stylization of such aspects and techniques are only examples of the virtually unlimited alternatives falling within the scope of the invention.

More generally, the exact detailed embodiments provided throughout this application, including the aspects and techniques set forth in the figures and discussed in detail in this application are, of course, examples, and not limiting. Rather, these embodiments are intended only as a reasonable set of possible example systems, graphics, structures, substructures, G.U.I.s, methods, steps, techniques and other aspects of the present invention, among virtually infinite and innumerable possibilities for carrying out the present invention, to ease comprehension of the disclosure, as will be readily apparent to those of ordinary skill in the art. For example, the description of one particular order, number or other arrangement of any aspects of the present invention set forth herein is illustrative, not limiting, and all other possible orders, numbers, arrangements, etc., are also within the scope of the invention, as will be so readily apparent. Any aspect of the invention set forth in this application may be included with any other aspect, as well as any aspects known in the art, in any number, order, arrangement, or alternative configuration, in particular embodiments, while still carrying out, and falling within the scope of, the invention.

FIG. 2 is a left side view of the example child-carrying stroller with a luggage bay set forth above, in FIG. 1, in accordance with some embodiments. From the different perspective of the present figure, additional aspects can be more clearly seen. For example, the garment-hanging hook(s) 169 may be seen more clearly, mounted on or otherwise connected with handlebar peripheral frame 155 of child-carrying stroller 101, such that a user can easily store a garment, shopping bag or other hangable item, in close proximity to handlebar(s) 157. In addition, a yoke 203 can now be more clearly seen. In some embodiments, yoke 203 includes a variably locking and releasing 3-point seatbelt fastener 205, fastened to three separate child-restraining seatbelts, forming a child-restraining harness 207 when so locked, in some embodiments: 1) a central, lower seatbelt 209 connected to the underside the child seating section 111 and configured to be placed between a child's legs when seated in the child-seating section 111; 2) an upper, right-hand side seatbelt 211, connected to the upper right-hand side of the seatback 154; and 3) an upper, left-hand side seatbelt 213, connected to the upper left-hand side of the seatback 154.

Also, from the unique perspective of the figure, the viewer has a perpendicular angle view of the left-hand side of example indicia 215, provided on or about outer surface(s) of the child-carrying stroller. In some embodiments, such indicia provide the identity of a brand or company associated with the marketing and management of the child-carrying stroller, among other possible information.

FIG. 3 is a right-side view of the example child-carrying stroller 101 with a luggage bay 103 set forth above, in FIG. 1, in accordance with some embodiments. As with the side view discussed in FIG. 2, above, in the different perspective of the present figure, additional aspects can be more clearly seen. For example, a second, right-hand side rear wheel 301 can now be plainly seen. In some embodiments, as pictured, second rear wheel 301 is of a similar nature to the rear wheel pictured in FIG. 2, above, and also includes a brake-namely, example right-hand side brake 353. However, in some embodiments second rear wheel 301 may be of a different nature and/or may not have such a brake.

Also, as with the opposite side view provided by FIG. 2, above, the viewer has an undistorted view of additional example indicia 381, provided on or about outer surface(s) of the child-carrying stroller. In some embodiments, such indicia provide the identity of a brand or company associated with the marketing and management of the child-carrying stroller, among other possibilities.

FIG. 4 is a perspective view of another example child-carrying stroller 401, in accordance with additional embodiments. In some such embodiments, child-carrying stroller 401 includes any number of the aspects, components and techniques set forth above, with reference to similar child-carrying stroller 101. However, in some embodiments, additional and/or alternative aspects can now be seen. For example, in some embodiments, a rounded strut 402 is provided, rather than a flattened platform and/or flat bottom-defining strut, at or about the bottom of luggage bay 403.

In addition, a swivel-mounted feeding tray 463 is provided on an additional peripheral frame 465, which is capable of toggling between two positions: 1) a feeding position (not pictured in the present figure), in which the feeding tray is in a generally horizontal orientation, and 2) a raised position 467, in which the feeding tray is in a generally vertical orientation, and an underside 469 of the feeding tray is exposed and positioned out of the way of an entrance to the baby seat, as now shown.

Furthermore, yoke 405, which may be similar or identical to the example yoke 203, discussed above, can be clearly seen. In some embodiments, yoke 405 includes a variably locking and releasing 3-point seatbelt fastener, fastened to three separate child-restraining seatbelts, forming a child-restraining harness when so locked, in some embodiments: 1) a central, lower seatbelt 471 connected to the underside the child seating section 411 and configured to be placed between a child's legs when seated in the child-seating section 411; 2) a right-hand side seatbelt 472, connected the upper right-hand side of the seatback 413; and 3) a left-hand side seatbelt 473, connected to the upper left-hand side of seatback 413.

In addition, both of two rear wheels 475, either or each of which may be of a similar nature to any of embodiments of rear wheels discussed above.

It should be mentioned that, in some embodiments, any of the strollers may be of any size, height, width and length suitable for child-carrying strollers. In some embodiments, either or both of child-carrying strollers 101 and 401 are, or approximately are, 40.5 inches in length and 23.6 inches in width) in some embodiments. However, these measurements provided are only examples of the virtually unlimited number of dimensions that may, alternatively or in addition, be implemented, in various embodiments. As another example, in some embodiments, any embodiment of any stroller set forth in the present application may be approximately 33 inches long and 24 inches wide.

It should be mentioned again that, the exact embodiments discussed above are merely examples of the virtually unlimited number of possible embodiments, and the number and combinations of the components and other aspects as set forth in this application, which fall within the scope of the inventions, as will be clear to those of ordinary skill in the art. For example, although a single child-seating section and/or seat, suitable for accommodating a single child, has been set forth herein, it should be understood that any possible number, arrangement and combination of child-seating sections and areas may be, alternatively, provided. In some embodiments, the child-seating section is configured to hold a plurality of children. A single child-seating section, including a single child seat, and luggage bay are preferred. However, in some embodiments, there are multiple child-seating sections and/or luggage bays. For example, in some embodiments, the stroller includes a “2-and-1” configuration (e.g., with two baby-holding seating sections, e.g., above, and one guarded luggage bay, below).

FIG. 5 is a schematic block diagram of some elements of a control system 500, including computer hardware and software, in accordance with some example embodiments of the invention. In some example embodiments, the control system incorporates a non-transitory machine-readable me medium, storing instructions that, when executed by one or more processors, execute various aspects of the present inventions described in this application. The generic and other components and aspects described herein are not exhaustive of the many different systems and variations, including a number of possible hardware aspects that might be used, in accordance with the example embodiments of the invention. Rather, the control system 500 shown depicts some example embodiments.

Control system 500 includes an input/output device 501, a memory device 503, long-term data storage device 505, and processor(s) 507. The processor(s) 507 is (are) capable of receiving, interpreting, processing and manipulating signals and executing instructions for further processing and for output, pre-output and/or storage in and outside of the system. The processor(s) 507 may be general or multipurpose, single- or multi-threaded, and may have a single core or several processor cores, including microprocessors. Among other things, the processor(s) 507 is/are capable of processing signals and instructions for the input/output device 501, to cause a user interface to be provided or modified for use by a user on hardware, such as, but not limited to, computer system peripheral devices, such as a mouse, keyboard, touchscreen and/or other display, such as example stroller-mounted tablet computer and display 519, providing specialized tools (e.g., providing a graphical user interface, a.k.a. a “G.U.I.,” providing any of the G.U.I. tools and functions discussed forth in this application, e.g., for managing strollers and stroller rentals, and G.U.I. sub-tools related to the same, as set forth in greater detail elsewhere in this application). In some embodiments, such GUI tools are based on display-controlling and input-facilitating software (e.g., on local machine(s) 511, stroller-mounted tablet computer and display 519 or PDA 520).

For example, G.U.I. tools and other user interface aspects, such as any of the graphical “windows,” “buttons,” and data entry fields, may present via, for example, a display, any number of selectable options, actions, commands and/or data entry fields set forth elsewhere in this application. When such options, actions and/or data entry fields are selected or data is entered by a user (e.g., an administrative user), such selection and/or data entry causes aspects of the control system to command other aspects of the control system to take particular actions and present additional instructions, G.U.I. tools and sub-tools, and/or other guidance to users related to managing child-carry strollers, as set forth in this application. For example, in some embodiments, the control system may generate an (e.g., artificial intelligence) algorithm for determining when and how to safely arrest the movement of a child-carrying stroller. The processor(s) 507 may execute instructions stored in memory device 503 and/or long-term data storage device 505, and may communicate via system bus(ses) 575. Input/output device 501 is capable of input/output operations for the system, and may include and communicate through input and/or output hardware, and instances thereof, such as a computer mouse, scanning device or other sensors, actuator(s), communications antenna (ae), keyboard(s), smartphone(s) and/or PDA(s), networked or connected additional computer(s), camera(s) or microphone(s), a mixing board(s), real-to-real tape recorder(s), external hard disk recorder(s), additional movie and/or sound editing system(s) or gear, speaker(s), external filter(s), amp(s), preamp(s), equalizer(s), computer display screen(s) or touch screen(s). Such input/output hardware could implement a program or user interface created, in part, by software, permitting the system and user to carry out the user settings and input discussed in this application. Input/output device 501, memory device 503, data storage device 505, and processor(s) 507 are connected and able to send and receive communications, transmissions and instructions via system bus(ses) 575. Data storage device 505 is capable of providing mass storage for the system, and may be or incorporate a computer-readable medium, may be a connected mass storage device (e.g., flash drive or other drive connected to a Universal Serial Bus (USB) port or Wi-Fi), may use back-end (with or without middle-ware) or cloud storage over a network (e.g., the Internet) as either a memory backup for an internal mass storage device or as a primary memory storage means, or may simply be an internal mass storage device, such as a computer hard drive or optical drive. Generally speaking, the system may be implemented as a client/server arrangement, where features of the system are performed on a remote server, networked to the client and made a client and server by software on both the client computer and server computer. In any event, the system may include, or include network connections (e.g, wired, WAN, LAN, 5G, ethernet, satellite, and/or Internet connections) with, any of the example devices or auxiliary devices and/or systems, shown as Internet server(s) 509, local machine(s) 511, cameras and microphones 513, sensor(s) 514, internet of things or other ubiquitous computing devices 515, application programming interface (“API”) 517, scanner 518 and PDA 520. Similarly, the control system 500 is capable of accepting input from any of those auxiliary devices and systems, and modifying stored data within them and within itself, based on any input or output sent through input/output device 501.

Input and output devices may deliver their input and receive output by any known means, including, but not limited to, any of the hardware and/or software examples shown as internet server(s) 509, local machine(s) 511, cameras and microphones 513, sensor(s) 514, internet of things or other ubiquitous computing devices 515, API 517, stroller-mounted tablet computer and display 519 and PDA 520.

While the illustrated example of a control system 500 in accordance with the present invention may be helpful to understand the implementation of aspects of the invention, any suitable form of computer system known in the art may be used—for example, in some embodiments, a simpler computer system containing just a processor for executing instructions from a memory or transmission source. The aspects or features set forth may be implemented with, and in any combination of, digital electronic circuitry, hardware, software, firmware, middleware or any other computing technology known in the art, any of which may be aided with external data from external hardware and software, optionally, by networked connection, such as by LAN, WAN, satellite communications networks, 5G or other cellular networks, and/or any of the many connections forming the Internet. The system can be embodied in a tangibly-stored computer program, as by a machine-readable medium and propagated signal, for execution by a programmable processor. The many possible method steps of the example embodiments presented herein may be performed by such a programmable processor, executing a program of instructions, operating on input and output, and generating output and stored data. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

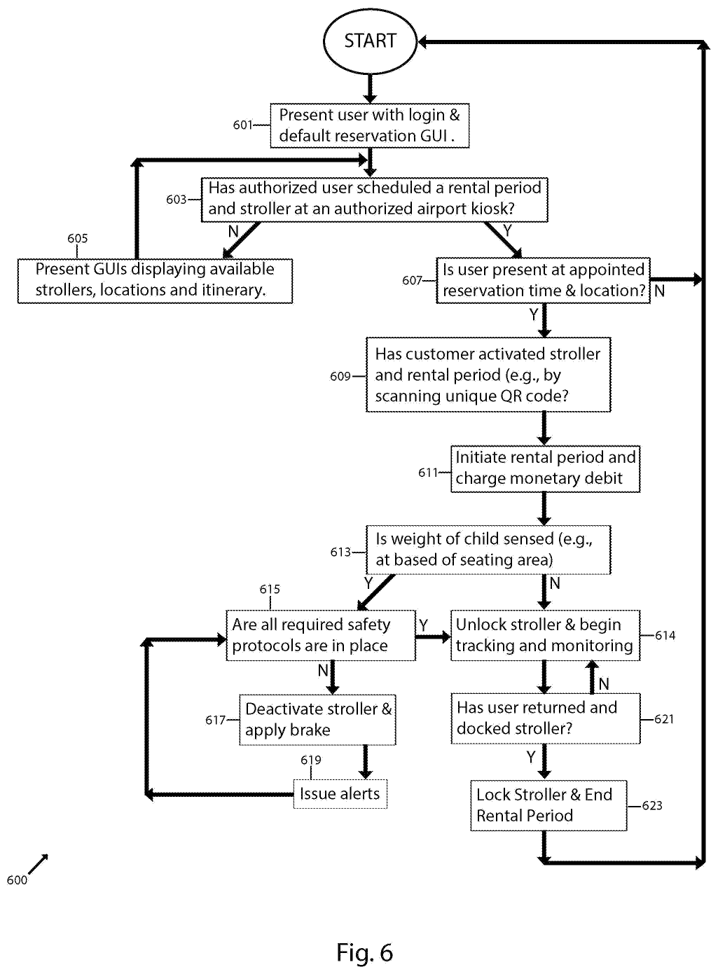

FIG. 6 is a process flow diagram, illustrating several example steps 600 that may be carried out by a control system, such as the example control system set forth in reference to FIG. 5, comprised in, or comprising, a stroller rental management system, in accordance with some additional embodiments. As discussed above, in some embodiments, strollers in accordance with aspects of the present application include a control system, including computer hardware and software, and a wheel brake, actuable by the control system.

Beginning with Step 601, in some embodiments, the control system presents a GUI to an adult user of the control system seeking to reserve and/or manage a rental of child-carrying stroller, such as any of the embodiments of child-carrying strollers set forth in the present application. Such a GUI may include any of a wide variety of GUI tools and elements, in various embodiments, suitable for that purpose. For example, in some embodiments, the GUI may include data entry screens and windows prompting the user for login and/or authentication credentials, identifying the user as an authorized user. In some embodiments, the control system may also present GUI tools including a maps, calendar and itinerary, from which the user may view booked and available periods of time and locations of such child-carrying strollers, and select such a period of time and location for such a rental, as discussed further below.

If the user has been so authenticated, the control system may proceed to step 603, in which it determines whether the user has yet selected an available stroller and location (e.g., a kiosk at an airport) and scheduled a rental for an available time period, for which the stroller is not yet reserved by another user. If not, the control system proceeds to step 605, in which it presents such GUI tools, from which the user may view booked and available periods of time and locations of such child-carrying strollers, and select such an available period of time and location for such a rental. In some embodiments, as discussed above, such GUI tools include a map(s), calendar(s) and/or itinerary screen(s) providing itinerary details regarding the timing of a flight that the user has booked, and a recommended rental time period to accommodate such an itinerary.

Next, in step 607, the control system determines whether the user has arrived at or before the start time of the appointed rental time period and the location selected for the stroller rental (e.g., at an authorized airport kiosk), or, in some embodiments, within a grace period before and after the start time. If not, the control system may return to the starting position. But, if so, the control system proceeds to step 609, in which it determines whether the user has activated the reserved child-carrying stroller.

In various embodiments, the user may activate the reserved stroller upon arrival at or before the start time at the location selected in a number of ways, alone or in combination, in some such embodiments. For example, in some embodiments, the user may use her or his PDA (e.g., a smartphone running at least part of the software carrying out the steps for a control system set forth in this application) to scan a QR code, or other scannable identifier presented on an outer surface of the stroller. In some embodiments, such a scannable identifier is unique to the individual stroller which the user has reserved. By scanning the scannable identifier, the user unambiguously indicates that she or he is present at the location of the stroller which, in turn, may be indicated by a location tag (e.g., a geolocation tag) at the time the scan is performed (which may be determined by the control system with reference to a clock or other chronometer subsystem of the control system. The control system then initiates the rental period, in some embodiments, in step 611, and, in some such embodiments, charges a monetary debit to the user's account maintained on the control system.

Next, the control system unlocks the stroller, for example, by deactivating a braking device located (e.g., on or about one or more wheels of the stroller) in some embodiments. In some embodiments, the control system begins the rental period, as discussed above, at the same time that it deactivates the braking device. However, in some embodiments, the control system begins the rental period beforehand. In any event, in some embodiments, the control system will not unlock the stroller (and/or, in some such embodiments, begin the rental period) unless and until a child is properly seated and secured in a child-seating section of the stroller. For example, in some embodiments, the stroller includes a weight or object sensor within the seating section (e.g., at or about the base of the seat) and, in step 613, the control system determines whether the weight of a child is sensed. In some embodiments, the control system may unlock the stroller, in Step 614 (but, in some embodiments, may not), if no child is so sensed. But, if the weight of a child is sensed, then, in subsequent step 615, the control system may then determine whether all seatbelts are properly secured about the child, for example, by sensing whether all such seatbelts are inserted and locked into a yoke of the 3-point or other harness (e.g., via a switch within the yoke activated by proper insertion and locking of the seatbelt clip into a buckle of the yoke, with which it interlocks). Of course, the example of ensuring that all seatbelts are properly secured is only one of virtually unlimited possible safety protocols, the presence of which may be sensed in step 615. If not so sensed, in step 617, the control system may deactivate, or not activate, the stroller (e.g., by sending a signal actuating the brake) unless and until all seatbelts are properly secured about the child, for example, by sensing whether all such seatbelts are inserted and locked into a yoke of the 3-point or other harness and/or seatbelt buckle of the stroller. In step 619, the control system may then proceed to issue alerts, through the control system, of the safety-related deactivation and arrest of the stroller, to the user and/or others. In some embodiments, such alerts include instructions as to how to satisfy the safety protocols, and reactivate the stroller. The control system then returns to step 615 et seq. and, if the user addresses the alerts, by carrying out the unsatisfied safety protocols subject to the alert, the control system proceeds to step 614, discussed above, unlocking the stroller, and beginning to track the location, and monitor movements, of the stroller during the rental period, in some embodiments, until such safety protocols are again not satisfied, or until the user returns the stroller (e.g., at the end of the rental period), in step 621. In some embodiments, the user ends the rental period by properly docking the stroller e.g., nesting the stroller with another, similar stroller, at a stroller return kiosk of the airport, as sensed by geolocation of the stroller and, or nesting sensors. The control system then locks the stroller and ends the rental period, and returns to the starting position, in some embodiments.

As discussed above, in some such embodiments, the control system disables the stroller from movement when a time period has elapsed or a point in time is reached. For example, in some embodiments, such a time period is a rental period, for which a user has rented the stroller. In some embodiments, the control system extends the rental period, while charging a monetary fee to a user for the extension, under certain conditions (for example, when a user's flight is monitored and recorded by the control system as being delayed). In some embodiments, the control system applies the wheel brake (e.g., in a pattern of pulsed braking) to provide haptic feedback to the user, e.g., to signal to the user that the rental period has been extended or otherwise changed). However, in some embodiments, other forms of feedback are provided to the user by the control system (e.g., text messages to a user's personal digital assistance (“PDA”).) In some embodiments, the control system begins, and/or ends a rental period when a user scans a QR code, license plate, and/or other stroller-identifying code, located on a visible surface of the stroller.

However, to aid in hazards created by instantaneously applying a braking mechanism to the stroller, and to notify the user while allow some movement by the stroller while it is being disabled, in some embodiments, a “slow brake” technique is applied to at least one wheel of the stroller, increasing safety. In some such embodiments, such a slow brake gradually creates increasing friction or other braking force at or about the point in time when the rental period has elapsed.

In some embodiments, strollers in accordance with the present invention include a control system, including computer hardware and software, and a wheel brake, actuable by the control system. In some embodiments, the control system disables the stroller from movement when a time period has elapsed or a point in time is reached. For example, in some embodiments, such a time period is a rental period, for which a user has rented the stroller. In some embodiments, the control system extends the rental period, while charging a monetary fee to a user for the extension, under certain conditions (for example, when a user's flight is monitored and recorded by the control system as being delayed). In some embodiments, the control system applies the wheel brake (e.g., in a pattern of pulsed braking) to provide haptic feedback to the user, e.g., to signal to the user that the rental period has been extended or otherwise changed). However, in some embodiments, other forms of feedback are provided to the user by the control system (e.g., text messages to a user's personal digital assistance (“PDA”).) In some embodiments, the control system begins, and/or ends a rental period when a user scans a QR code, license plate, and/or other stroller-identifying code, located on a visible surface of the stroller.

In some embodiments, the control system disables the stroller from movement when sensors indicate that a child is not properly seated in a child seat (located within a seating section of the stroller, as discussed further below). For example, in some embodiments, as discussed above, the control system disables the stroller from movement when sensors indicate that a child-restraining safety belt or harness (e.g., a 3-point harness, as pictured) is not properly fitted or closed over a child seated in such a child seat.

However, to aid in hazards created by instantaneously applying a braking mechanism to the stroller, and to notify the user while allow some movement by the stroller while it is being disabled, in some embodiments, a “slow brake” technique is applied to at least one wheel of the stroller, increasing safety. In some such embodiments, such a slow brake gradually creates increasing friction or other braking force at or about the point in time when the rental period has elapsed.

In some embodiments, one or more wheel brakes of the stroller is also manually actuable, by a user. In some such embodiments, the user may signal to the system that a rental period has ended by manually actuating the brake, and fully locking at least one wheel of the stroller (e.g., after returning the stroller to a return location (e.g., within an airport).

In some embodiments, the stroller 101 comprises a wheel lock 113 which is gradually, increasingly applied, at the end of a rental period in which a user rents and uses the stroller.

In some embodiments, the stroller 101 comprises a wheel lock which is applied in a pattern, signaling a user who rents and uses the stroller.

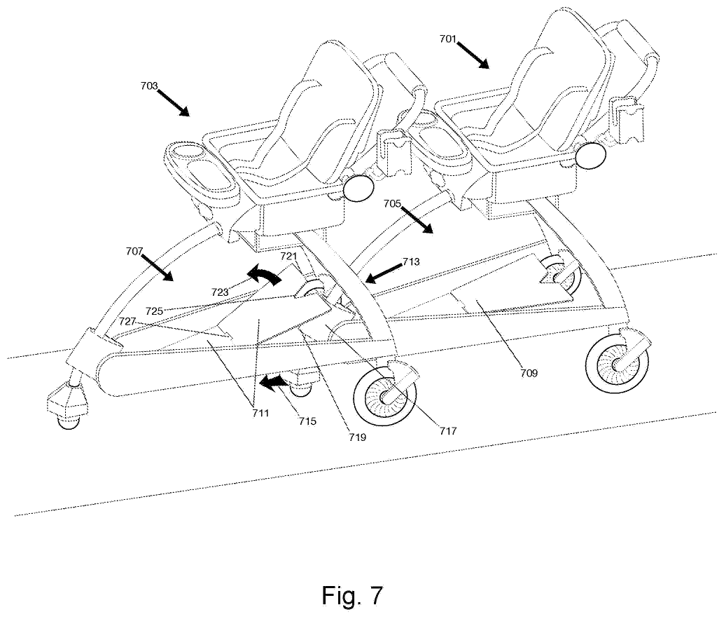

FIG. 7 is a perspective view of two additional example alternative embodiments of a child-carrying stroller 701 and child-carrying stroller 703, each with a luggage bay, such as example luggage bay 705 and example luggage bay 707, each of which, in turn, includes a hinged, raisable generally flattened floor, such as example hinged, raisable generally flattened floor 709 and example hinged, raisable generally flattened floor 711, respectively, in accordance with some additional embodiments. In accordance with some embodiments, child-carrying stroller 701 and child-carrying stroller 703 may be identical, or similar, in design and capabilities to each other. However, stroller 703 is shown in a condition allowing for an example more space-efficient configuration, in accordance with embodiment set forth above.

In some methods of use, in accordance with some embodiments, a user may line up and stow child-carrying strollers in accordance with the present application, after completing a use cycle or otherwise upon returning them. In some such embodiments, one of such child-carrying strollers, such as example child-carrying stroller 701, may be wheeled forward and into a rear valence 713 of another stroller—namely, in the present example, child carrying stroller 703—in the direction indicated by example push motion arrow 715. As the user so pushes child carrying stroller 703, in some embodiments, a front bracket 717, which, in some embodiments, may be the same as or similar in nature to, the example front bracket 127, discussed above with respect to example child-carrying stroller 101, or other generally rounded or pointed tip 719, may insert into rear valence 713, collide with a rear edge 721 of hinged, raisable generally flattened floor 711 and lift hinged, raisable generally flattened floor 711 upward, as shown by example rotary motion arrow 723. In some embodiments, front bracket 717 may collide with an inset guidance notch 725, and thereby so lift hinged, raisable generally flattened floor 711 upward, as pictured.

Thus, because the luggage bay 707 is presently not in use, the raisable generally flattened floor 711 is pivoted, at example hinge 727, up and forward, along the two strollers to nest, and strollers are stowed in a space-efficient manner.

However, it should be understood that, in some embodiments, a hinged, raisable or otherwise movable, generally flattened floor may be omitted, while still permitting for some nesting storage, with such a front wheel housing and/or other generally rounded or pointed tip still entering and nesting with a similar stroller.

In some embodiments, inset guidance notch 725 may include a downward-sloped side 727, to aid in causing such pivoting and rotary motion. However, in other embodiments, other methods for pivoting, rotating lifting or otherwise removing hinged, raisable generally flattened floor 711 may instead, or in addition, be used (e.g., a rotary actuator and/or a slightly upwardly-sloped hinged, raisable generally flattened floor 711) (from front to back), which is preferred for some uses, due to its tendency to secure luggage toward the front of the stroller when in use.

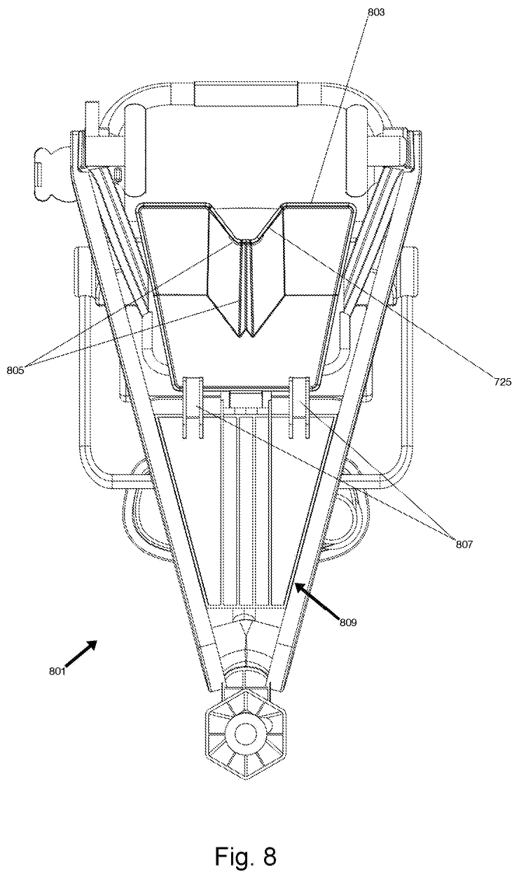

FIG. 8 is a bottom view of an example embodiment of a child-carrying stroller 801, which may be the same as or similar in nature to, each of the child-carrying strollers set forth above, in reference to FIG. 7, having a luggage bay including a hinged, raisable generally flattened floor, in accordance with some additional embodiments. From the perspective of the figure, aspects of the inset guidance notch 725 of a hinged, raisable generally flattened floor 803 can be seen, along with reinforcing contours 805 thereof. And, as also may be seen from the perspective of the figure, are floor-supporting tabs 807, disposed on the underside 809 of child-carrying stroller 801, which prevent generally flattened floor 803 from rotating below (i.e., toward the viewer) a horizontal configuration.

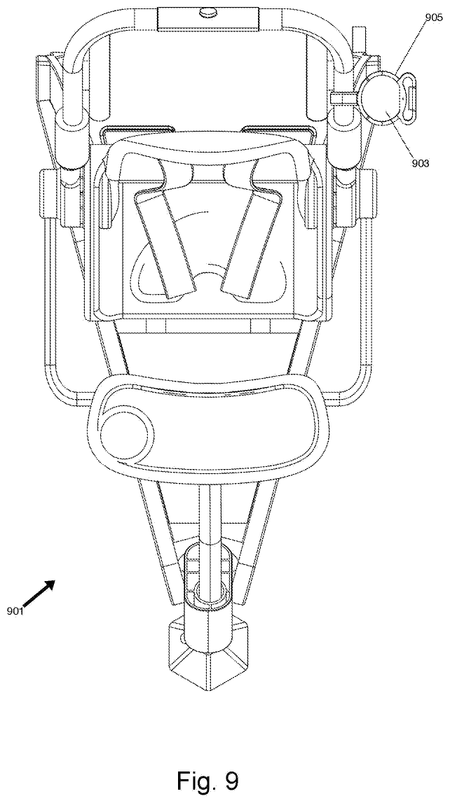

FIG. 9 is a top view of an example embodiment of a child-carrying stroller 901, which may be the same as or similar in nature to, each of the child-carrying strollers set forth above, in reference to FIGS. 7 and 8, in accordance with some additional embodiments.

From the perspective of the figure, certain aspects can be better seen, such as the central storage space of storage pocket 903, of example personal digital device holder 905, which may be the same as, or similar in nature to, other example personal digital device holders of the present application, such as example personal digital device holder 167, discussed above.

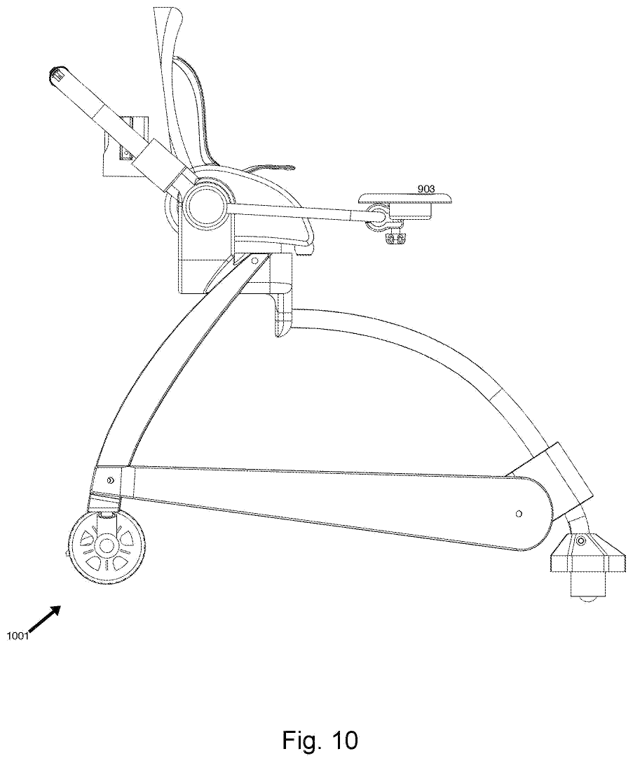

FIG. 10 is a right, side view of an example embodiment of a child-carrying stroller 1001, which may be the same as or similar in nature to, each of the child-carrying strollers set forth above, in reference to FIGS. 7-9, in accordance with some additional embodiments.

It should be noted that, although a seatbelt fastener, yoke and harness has not been shown in the perspective of the figure, and example shoulder belts 1003 are instead shown suspended in space, in some embodiments, such a seatbelt fastener, yoke and/or hamess, which may be the same as or similar in nature to example 3-point seatbelt fastener 205, example yoke 405 and/or child-restraining harness 207, may be included, as discussed in reference to other embodiments of child-carrying strollers set forth above.

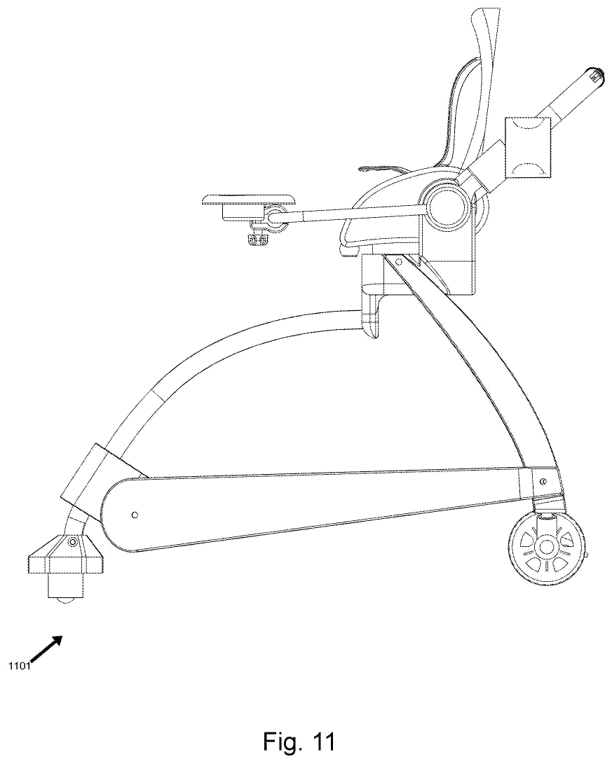

FIG. 11 is a left, side view of an example embodiment of a child-carrying stroller 1101, which may be the same as or similar in nature to, each of the child-carrying strollers set forth above, in reference to FIGS. 7-10, in accordance with some additional embodiments.

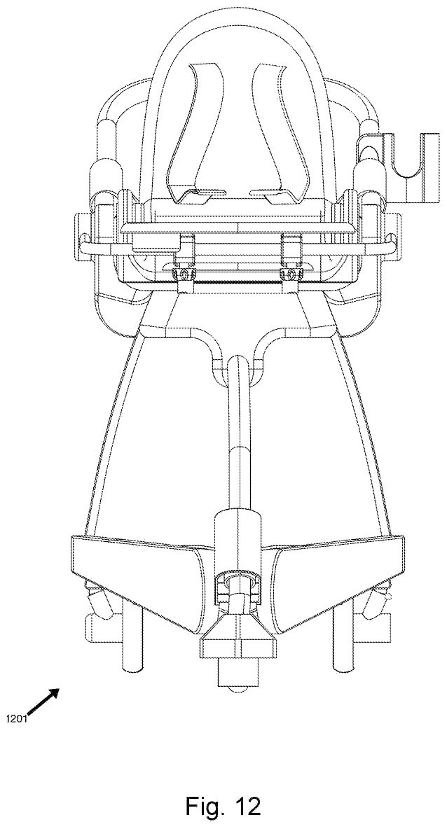

FIG. 12 is a front view of an example embodiment of a child-carrying stroller 1201, which may be the same as or similar in nature to, each of the child-carrying strollers set forth above, in reference to FIGS. 7-11, in accordance with some additional embodiments.

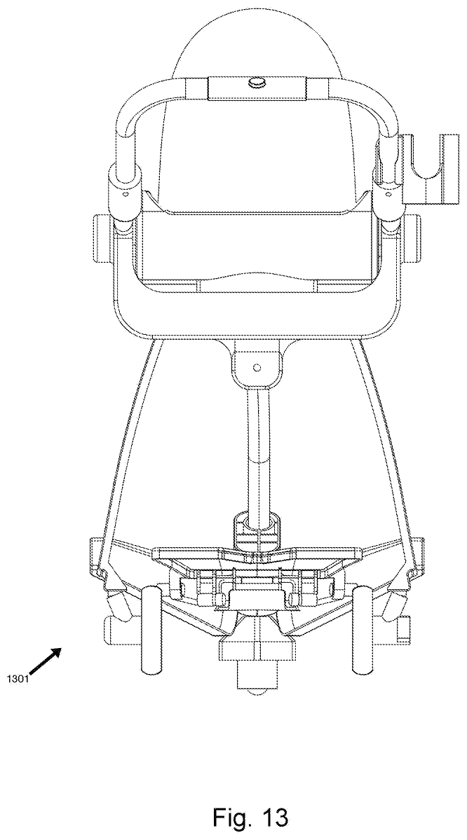

FIG. 13 is a back view of an example embodiment of a child-carrying stroller 1301, which may be the same as or similar in nature to, each of the child-carrying strollers set forth above, in reference to FIGS. 7-12, in accordance with some additional embodiments.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A stroller, comprising:
a seating section, suitable for holding a child;
a luggage bay, connected below said seating section, to receive at least one piece of luggage;
at least three wheels, mounted below said luggage bay;
a wheel lock, mounted to at least one of said at least three wheels to impede movement of the stroller;
an actuator, for moving said wheel lock between locked and unlocked positions; and
a controller configured to communicate with said actuator to unlock said wheel lock.

18. The stroller of claim 17 wherein said controller receives a wireless signal from a user.

19. The stroller of claim 17, further comprising a personal item storage area with a stretchable bag or compartment and an upward-facing, stretchable opening and force biasing.

20. The stroller of claim 19, wherein said personal item storage area includes a box located between said seating section and a protective cage.

21. The stroller of claim 17, wherein said seating section includes a seatback that is fully reclinable, to a horizontal orientation.

22. The stroller of claim 17, wherein one of said at least three wheels is a front wheel that comprises a ball wheel, mounted in a socket, and configured for 360-degree swiveling and unlimited rotation.

23. The stroller of claim 17, wherein two of said at least three wheels are round wheels.

24. The stroller of claim 23, wherein said two round wheels are also configured for 360-degree swiveling.

25. The stroller of claim 17, further comprising an open back, configured for nesting with at least one other stroller, of a similar size shape and configuration to the stroller.

26. The stroller of claim 17, further comprising:
at least one lock sensor mounted below the seating section; and
at least one tracking sensor.

27. The stroller of claim 26, wherein said at least one lock sensor is configured to configured to recognize when a child is not properly seated in said seating section.

28. The stroller of claim 27, wherein said lock sensor is configured to communicate with the controller to lock said wheel lock when a child is not properly seated in said seating section.

29. The stroller of claim 26, wherein said at least one tracking sensor configured to monitor the location and duration of use of the stroller.

30. The stroller of claim 29, wherein said tracking sensor is configured to communicate the location and duration of use of said stroller to said controller.

31. The stroller of claim 17, wherein said wheel lock is applied at the end of a rental period in which a user rents and uses the stroller.

32. The stroller of claim 17, wherein said wheel lock is also manually actuable by an adult user of the stroller.

33. The stroller of claim 17, wherein said controller is configured to communicate with said actuator to move said wheel lock to a locked position.

34. The stroller of claim 17, further comprising:
at least one handlebar;
at least one PDA storage pocket; and
an electronic interface, located on or about said at least one handlebar.

35. A stroller system comprising:
a plurality of strollers having wheels;
a plurality of controllers, one mounted to each said plurality of strollers;
a plurality of wheel locks, one each on at least one wheel of each said plurality of strollers;
a plurality of actuators, one each on at least one wheel lock of each said plurality of wheel locks; and
an app compatible to connect to any of said plurality of strollers to communicate with said plurality of controllers to control movement of said plurality of strollers.

36. The stroller system of claim 35 wherein the app is configured to:
communicate with the controller mounted to the stroller to determine the location of at least one stroller;
provide the location of at least one stroller to a user;
accept payment information from a user;
provide airport information to a user; and
communicate information related to the rental and use of at least one stroller to said controller.

37. The stroller system of claim 35 wherein said plurality of controllers are configured to:
communicate with said plurality of actuators to move said plurality of wheel locks of at least one wheel of at least one stroller between locked and unlocked positions;
accept locking and unlocking data and other information from said app to authorize the use of said at least one stroller; and
communicate location information and status data from at least one stroller to said app.
